(19) United States
(12) Patent Application Publication
(10) Pub. No.: US 2015/0224704 A1
(43) Pub. Date: Aug. 13, 2015

(54) MASTER MOLD, IMPRINT MOLD, AND METHOD OF MANUFACTURING DISPLAY DEVICE USING IMPRINT MOLD

(71) Applicant: SAMSUNG DISPLAY CO., LTD., Yongin-City (KR)

(72) Inventors: Hyunmin Cho, Asan-si (KR); Ji Hun Kim, Asan-si (KR); Gwan Ha Kim, Hwaseong-si (KR); Sanggab Kim, Seoul (KR); Jungha Son, Seoul (KR)

(21) Appl. No.: 14/526,453

(22) Filed: Oct. 28, 2014

(30) Foreign Application Priority Data
Feb. 12, 2014 (KR) 10-2014-0016135

(51) Int. Cl. B29C 59/02

(52) U.S. Cl. CPC B29C 59/022; B29C 59/026; B29L 2031/3475

(57) ABSTRACT

A master mold for manufacturing an imprint mold includes a base part and a plurality of protrusions extending from the base part. At least one first recess is defined in a side portion of each of the protrusions. Additionally, an imprint mold used or utilized to manufacture a display device includes a base part and a plurality of protrusions extending from the base part. Each of the protrusions includes at least one first convex portion protruding from a side portion of each of the protrusions.

### CROSS-REFERENCE TO RELATED APPLICATION

This application claims priority to and the benefit of Korean Patent Application No. 10-2014-0016135, filed on Feb. 12, 2014, the content of which is hereby incorporated by reference in its entirety.

### BACKGROUND

1. Field

Aspects of embodiments of the present invention relate to a master mold, an imprint mold, and a method of manufacturing a display device using (utilizing) the imprint mold. More particularly, aspects of embodiments of the present invention relate to a master mold and an imprint mold configured to accurately form a pattern on a display device, and a method of manufacturing a display device using (utilizing) the imprint mold.

2. Description of the Related Art

An imprint process is used to transfer an imprint pattern on a resin layer using an imprint mold on which the imprint pattern is formed. In particular, the imprint process is widely used to form a pattern on a thin film layer included in a display device. Forming the pattern on the thin film layer using the imprint process reduces process time and manufacturing cost as compared to forming the pattern using a photolithography process.

The imprint mold is typically manufactured using a master mold. Generally, since the imprint mold has better soft properties than a master mold, a lifespan of the imprint mold is often shorter than that of the master mold. Accordingly, when the imprint mold is utilized to mass produce display devices, the imprint mold may also be mass-produced using a master mold. Therefore, design of an imprint mold and a master mold in order to accurately form an imprint pattern on a thin film layer of a display device is critical.

### SUMMARY

Aspects of embodiments of the present invention are directed toward a master mold configured to accurately form a pattern on a display device.

Aspects of embodiments of the present invention are directed toward an imprint mold configured to accurately form a pattern on a display device.

Aspects of embodiments of the present invention are directed toward a method of forming a pattern on a display device using (utilizing) the imprint mold configured to accurately form a pattern on a display device.

According to one or more embodiments of the present invention, a master mold for manufacturing an imprint mold includes a base part and a plurality of protrusions extending from the base part. At least one first recess may be defined in a side portion of each of the protrusions of the plurality of protrusions.

Each of the protrusions may extend along a first direction, and the plurality of protrusions may be arranged on the base part along a second direction crossing the first direction to be spaced apart from each other.

The first recess may extend along the first direction, having its greatest depth at a centerline extending along the first direction at the side portion.

The first recess may be defined by a surface having a rounded shape.

At least one second recess may be defined in an upper portion of each of the protrusions.

The at least one second recess may extend along a centerline of the upper portion of each of the protrusions along the first direction.

Each of the protrusions may include auxiliary protrusions at two edges of an upper portion of each of the protrusions such that a corresponding one of the auxiliary protrusions is on each of the two edges.

Each of the auxiliary protrusions may have a polygonal cross-sectional shape.

At least one third recess may be defined on the base part and may extend along the first direction.

The first recess may be coupled to the third recess.

According to one or more embodiments of the present invention, an imprint mold for manufacturing a display device includes a base part and a plurality of protrusions extending from the base part. Each of the protrusions may include at least one first convex portion protruding from a side portion of each of the protrusions.

Each of the protrusions may extend along a first direction, and the protrusions may be arranged on the base part in a second direction crossing the first direction to be spaced apart from each other.

The first convex portion may extend in the first direction having a greatest thickness at a centerline extending along the first direction at the side portion.

Each of the protrusions may further include second convex portions at two upper edges facing each other such that a corresponding one of the second convex portions may be on each of the two upper edges.

Each of the second convex portions may have a polygonal cross-sectional shape.

The imprint mold may further include a third convex portion protruding from the base part and extending along the first direction between two adjacent protrusions of the plurality of protrusions. Each third convex portion may have a height less than that of each of the protrusions.

According to one or more embodiments of the present invention, a method of manufacturing a display device utilizing an imprint mold includes forming a pixel part on a first substrate, forming a preliminary grid polarization layer on at least one of the first substrate and a second substrate facing the first substrate, forming a resin layer on the preliminary grid polarization layer, imprinting the resin layer utilizing the imprint mold having a base part and a plurality of protrusions extending from the base part to form an imprinted resin layer, curing the imprinted resin layer to form mask layers, and patterning the preliminary grid polarization layer utilizing the mask layers as a mask to form grid polarization layers. A profile of a side portion of each of the mask layers may be flattened utilizing a first convex portion on a side portion of each of the protrusions during imprinting of the resin layer.

During the imprinting of the resin layer by the imprint mold, a profile of a residual layer under the mask layers may be flattened utilizing a second convex portion on an upper portion of each of the protrusions.

During the imprinting of the resin layer by the imprint mold, a profile of an upper portion of each of the mask layers may be flattened utilizing a third convex portion on the base part.

The grid polarization layers may have a pitch shorter than a wavelength of a visible light, and the visible light may be polarized or reflected by the grid polarization layers.

According to additional embodiments of the present invention, a shape of the mask layer used (utilized) to pattern the grid polarization layers included in the display device may be easily adjusted by using (utilizing) the imprint mold. Therefore, the profile of the side portion of each of the mask layers patterned using (utilizing) the imprint mold may be adjusted or manipulated to be in a straight line, thus, preventing or reducing deterioration of the optical function of the grid polarization layers.

### BRIEF DESCRIPTION OF THE DRAWINGS

The above and other advantages of embodiments of the present invention will become readily apparent by reference to the following detailed description when considered in conjunction with the accompanying drawings wherein:

FIG. 1A is a perspective view showing a master mold according to an embodiment of the present invention;

FIG. 1B is a cross-sectional view of the master mold taken along the line I-I′ shown in FIG. 1A;

FIG. 2A is a perspective view showing a master mold according to another embodiment of the present invention;

FIG. 2B is a cross-sectional view of the master mold taken along the line II-II′ shown in FIG. 2A;

FIG. 3 is a cross-sectional view showing a master mold according to another embodiment of the present invention;

FIG. 4 is a cross-sectional view showing a master mold according to another embodiment of the present invention;

FIG. 5A is a perspective view showing an imprint mold manufactured using (utilizing) the master mold shown in FIGS. 1A and 1B;

FIG. 5B is a cross-sectional of the imprint mold view taken along the line III-III′ shown in FIG. 5A;

FIGS. 6A and 6B are cross-sectional views illustrating a method of manufacturing the imprint mold shown in FIG. 5B using (utilizing) the master mold shown in FIG. 1A; and

FIGS. 7A to 7H are cross-sectional and perspective views illustrating a method of manufacturing a display device using (utilizing) the imprint mold shown in FIG. 5B.

### DETAILED DESCRIPTION

It will be understood that when an element or layer is referred to as being “on,” “connected to,” or “coupled to,” another element or layer, it can be directly on, connected to, or coupled to the other element or layer, or intervening elements or layers may also be present. In contrast, when an element is referred to as being “directly on,” “directly connected to,” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers, and/or sections, these elements, components, regions, layers, and/or sections are not be limited by these terms. These terms are only used to distinguish one element, component, region, layer, or section from another component, region, layer, or section. Thus, for example, a first element, component, region, layer, or section discussed below could be termed a second element, component, region, layer, or section without departing from the teachings of the present invention.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting. As used herein, the singular forms, “a,” “an,” and “the” are intended to include the plural forms as well, unless the context clearly indicates otherwise. It will be further understood that the terms “includes” and/or “including,” when used in this specification, specify the presence of stated features, integers, steps, operations, elements, components, and/or groups, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in further detail with reference to the accompanying drawings.

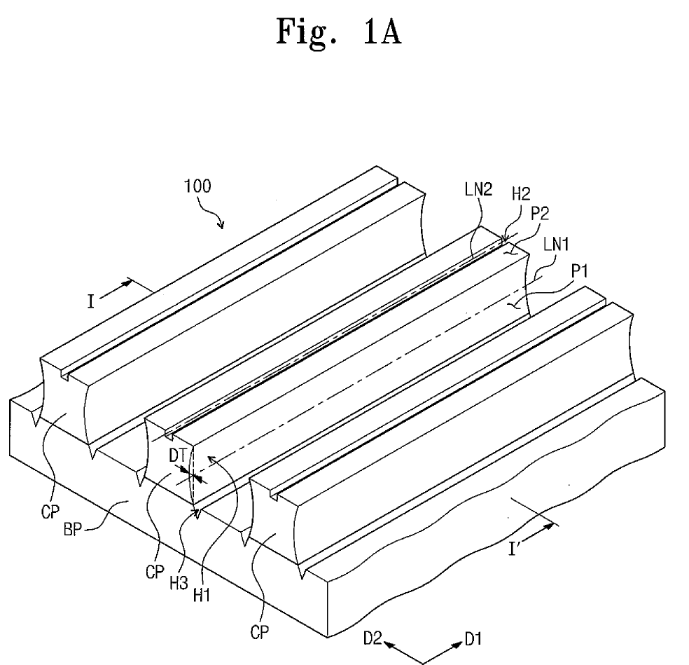

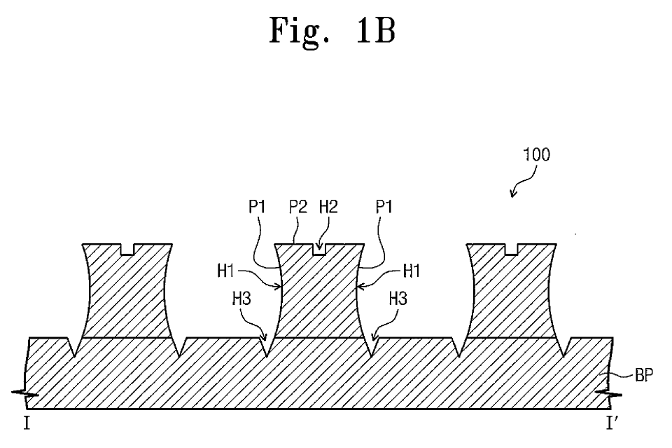

FIG. 1A is a perspective view showing a master mold 100 according to an embodiment of the present invention, and FIG. 1B is a cross-sectional view of the master mold 100 taken along the line I-I′ shown in FIG. 1A.

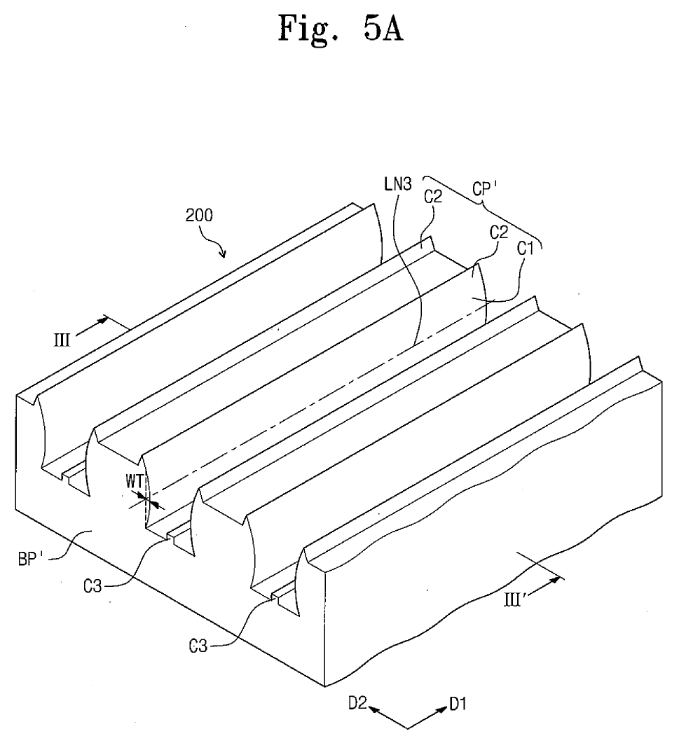

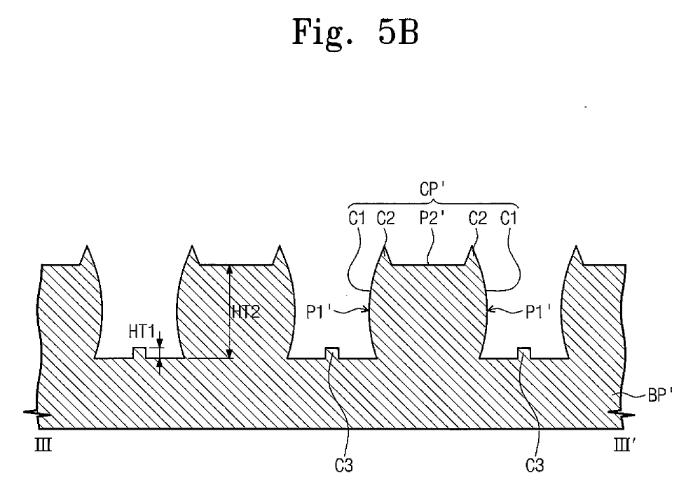

The master mold 100 shown in the embodiments in FIGS. 1A and 1B is used (utilized) to manufacture an imprint mold 200 (as shown in FIG. 5A).

The master mold 100, according to this embodiment, includes an inorganic material, e.g., silicon nitride, silicon oxide, etc., but is not limited thereto or thereby. According to another embodiment, the master mold 100 may include an organic material such as silicon resin, epoxy resin, etc.

The master mold 100, according to an embodiment, includes a base part BP and a plurality of protrusions CP. In an embodiment, the base part BP has a plate shape and the protrusions CP extend or protrude from the base part BP.

The protrusions CP, in this embodiment, are on the base part BP and extend in a first direction D1. The protrusions CP, in this embodiment, are also arranged in a second direction D2 crossing the first direction D1 at regular intervals. In this embodiment, the first direction D1 may be substantially perpendicular to (or crossing) the second direction D2. Hereinafter, one protrusion CP of the plurality of protrusions CP will be described in further detail as a representative example.

The protrusion CP, in an embodiment, includes side portions P1 with adjacent side portions P1 facing each other, and a first recess H1 defined in each of the side portion P1. As an example, the first recess H1 extends in the first direction D1 and has a rounded contour or cross-sectional shape. The first recess H1, in an embodiment, is defined by inwardly recessing or making concave a surface area of each of the side portions P1, for example in an elliptical or circular contour. Accordingly, if a first imaginary line LN1 were defined along the first direction D1 to halve each of the side portions P1, as shown in the embodiment in FIG. 1A, the first recess H1 would have its greatest depth DT on the first imaginary line LN1 halving each side portion P1.

According to another embodiment, although the depth DT of the first recess H1 is greatest on the first imaginary line LN1 as described above, surfaces defining the first recess H1 may have a flat cross-sectional shape.

The protrusion CP, according to an embodiment, includes an upper portion P2 having a second recess H2 in the upper portion P2. The second recess H2, in this embodiment, extends along the first direction D1 and is located at a center of the upper portion P2 when viewed in the cross-sectional view. Therefore, if a second imaginary line LN2 were defined along the first direction D1 to halve the upper portion P2, as shown in the embodiment in FIG. 1A, the second recess H2 is positioned at the second imaginary line LN2.

In this embodiment, surfaces defining the second recess H2 are flat, but are not limited thereto or thereby. According to another embodiment, the second recess H2 may be defined by a surface having a rounded contour or cross-sectional shape.

In an embodiment, third recesses H3 are defined in the base part BP. The third recess H3, according this embodiment, extend along the first direction D1 and are located at both or each respective side of the protrusion CP. In this embodiment, surfaces that define the third recesses H3 are flat, but are not limited thereto, and each third recess H3 may be defined by a surface having a rounded contour or cross-sectional shape.

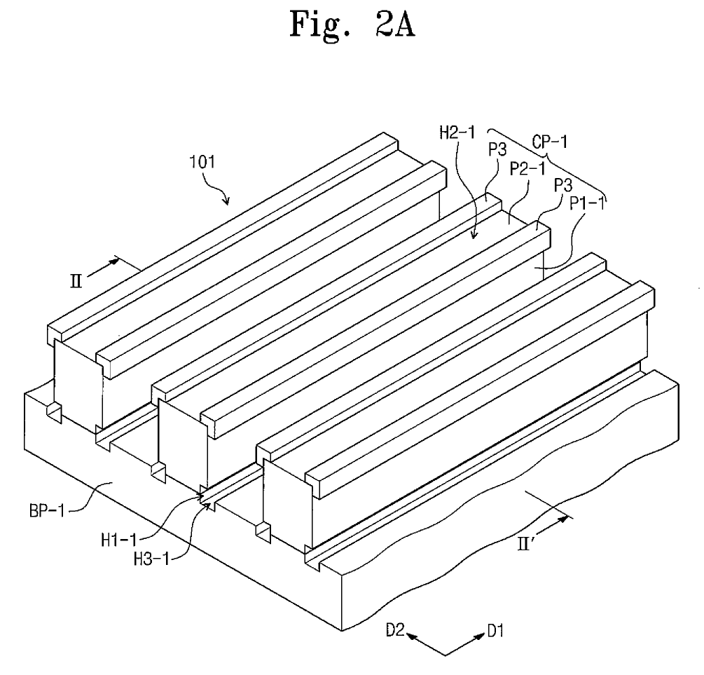

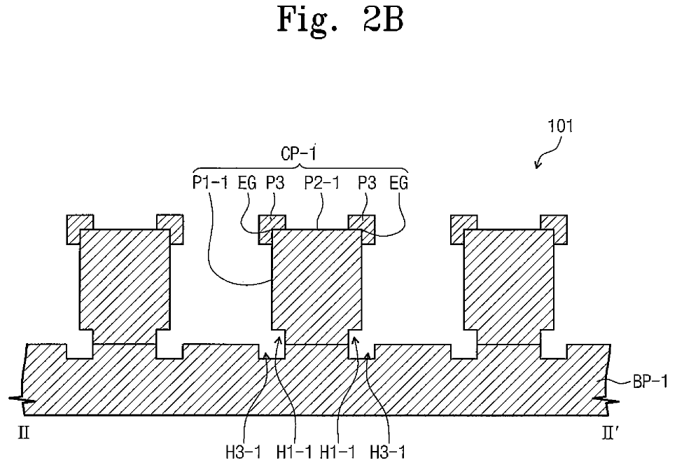

FIG. 2A is a perspective view showing a master mold 101 according to another embodiment of the present invention, and FIG. 2B is a cross-sectional view of the master mold 101 taken along the line II-II′ shown in FIG. 2A.

Referring to the embodiments shown in FIGS. 2A and 2B, the master mold 101 includes a base part BP-1 and a plurality of protrusions CP-1 extending from the base part BP-1. Hereinafter, one protrusion CP-1 of the plurality of protrusions CP-1 will be described in further detail with reference to FIGS. 2A and 2B.

The protrusion CP-1, according to this embodiment, includes auxiliary protrusions P3. The auxiliary protrusions P3, in this embodiment, are on an upper portion P2-1 of the protrusion CP-1 and located at two edges EG of the upper portion P2-1 which face each other, in a one-to-one relationship. In addition, each of the auxiliary protrusions P3 may have a polyhedron cross-sectional shape, and, the auxiliary protrusions P3 may be integrally formed with the protrusion CP-1.

As shown in the embodiments in FIGS. 2A and 2B a structure of the protrusion CP-1 and the auxiliary protrusions P3 is such that the center of the upper portion P2-1 of the protrusion CP-1 is inwardly recessed or concave by a set or predetermined depth due to a thickness of the auxiliary protrusions P3, thus defining a second recess H2-1 in the center of the upper portion P2-1 of the protrusion CP-1.

The protrusion CP-1, in an embodiment, includes side portions P1-1 with adjacent side portions P1-1 facing each other, and a first recess H1-1 defined in each of the side portions P1-1. In this embodiment, the first recess H1-1 extends along the first direction D1 and is defined by removing or blocking-out a portion of each of the side portions P1-1. When viewed in a cross-sectional view, flat surfaces define the first recess H1-1 in this embodiment, but the first recess H1-1 is not limited thereto or thereby. For example, according to another embodiment, the first recess H1-1 may be defined by a rounded contour or cross sectional-shaped.

In an embodiment, third recesses H3-1 are defined in the base part BP-1. The third recesses H3-1, in this embodiment, extend along the first direction D1 and are located at both or each respective side of the protrusion CP.

In this embodiment, the first recesses H1-1 are connected to the third recesses H3-1 in a one-to-one relationship such that a volume of a connected combination of a first recess H1-1 and a third recess H3-1 may be substantially the same as a sum of a volume of each of the first recess H1-1 and the third recess H3-1 taken separately and then summed.

Flat surfaces may define a cross-section of the third recess H3-1. However, according to another embodiment, the third recess H3-1 may be defined by a rounded contour or cross-sectional-shape.

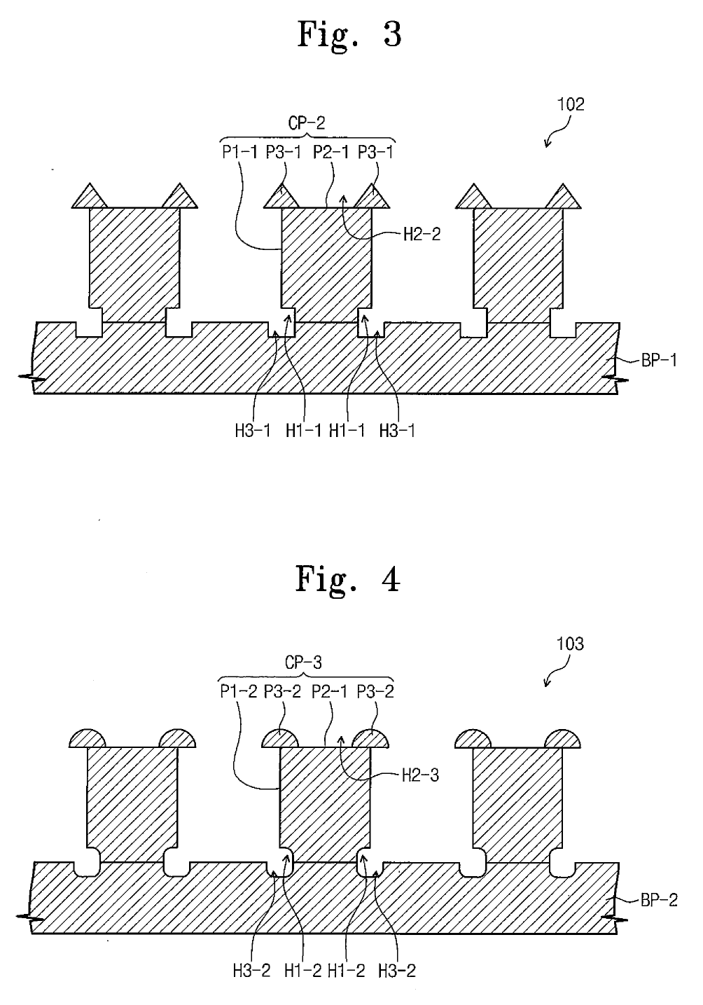

FIG. 3 is a cross-sectional view showing a master mold 102 according to another embodiment of the present invention. In FIG. 3, the same reference numerals denote the same elements in FIGS. 2A and 2B, and, thus, detailed descriptions of the same elements will be omitted.

Referring to the embodiment shown in FIG. 3, the master mold 102 includes the base part BP-1 and a plurality of protrusions CP-2 extending from the base part BP-1. Hereinafter, one protrusion CP-2 of the plurality of protrusions CP-2 will be described in further detail with reference to FIG. 3.

The protrusion CP-2, in this embodiment, includes auxiliary protrusions P3-1. The auxiliary protrusions P3-1, in this embodiment, are on an upper portion P2-1 of the protrusion CP-2 and located at two edges EG (for example, as shown in FIG. 2B) of the upper portion P2-1 which face each other, in a one-to-one relationship. In an embodiment, each of the auxiliary protrusions P3-1 may have a triangular contour or cross-sectional shape, and the auxiliary protrusions P3-1 may be integrally formed with the protrusion CP-2.

As shown in the embodiments in FIG. 3, a structure of the protrusion CP-2 and the auxiliary protrusions P3-1 is such that the center of the upper portion P2-1 of the protrusion CP-2 is inwardly recessed or concave by a set or predetermined depth due to a thickness of the auxiliary protrusions P3-1, thus defining a second recess H2-2 in the center of the upper portion P2-1 of the protrusion CP-2.

FIG. 4 is a cross-sectional view showing a master mold 103 according to another exemplary of the present invention. In FIG. 4, the same reference numerals denote the same elements in FIGS. 2A, 2B, and 3, and, thus, detailed descriptions of the same elements will be omitted.

Referring to the embodiment shown in FIG. 4, the master mold 103 includes a base part BP-2 and a plurality of protrusions CP-3 extending from the base part BP-2. Each of the protrusions CP-3 in this embodiment includes auxiliary protrusions P3-2, and each of the auxiliary protrusions P3-2 has a semi-circular contour or cross-sectional shape.

As described with reference to the embodiment shown in FIG. 3, the center of the upper portion P2-1 of each of the protrusions CP-3 is inwardly recessed or concave by a set or predetermined depth due to a thickness of the auxiliary protrusions P3-2, thus defining a second recess H2-3 in the center of the upper portion P2-1 of each protrusion CP-3.

In an embodiment, first recesses H1-2 are defined in adjacent side portions P1-2 facing each other at each of the protrusions CP-3, and third recesses H3-2 are formed in the base part BP-2 connected to the first recesses H1-2 in a one-to-one relationship. In the this embodiment, a surface defining each of the first recesses H1-2 and a surface defining each of the third recesses H3-2 may have a rounded contour or cross-sectional shape.

FIG. 5A is a perspective view showing an imprint mold 200 manufactured using (utilizing) the master mold shown in FIGS. 1A and 1B, and FIG. 5B is a cross-sectional view of the imprint mold 200 taken along the line III-III′ shown in FIG. 5A.

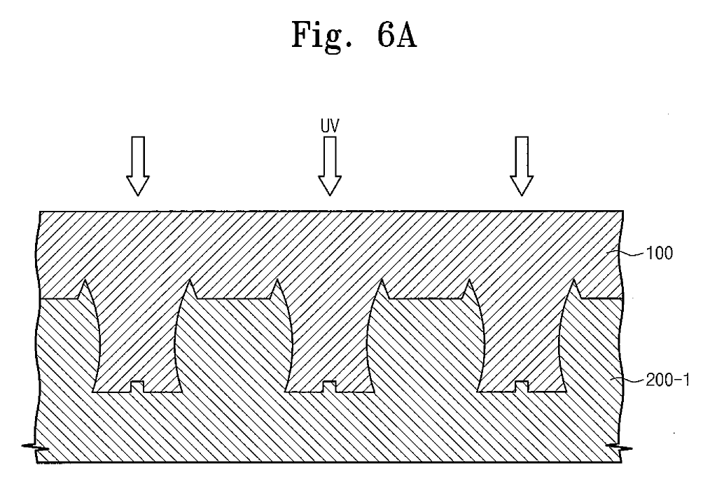

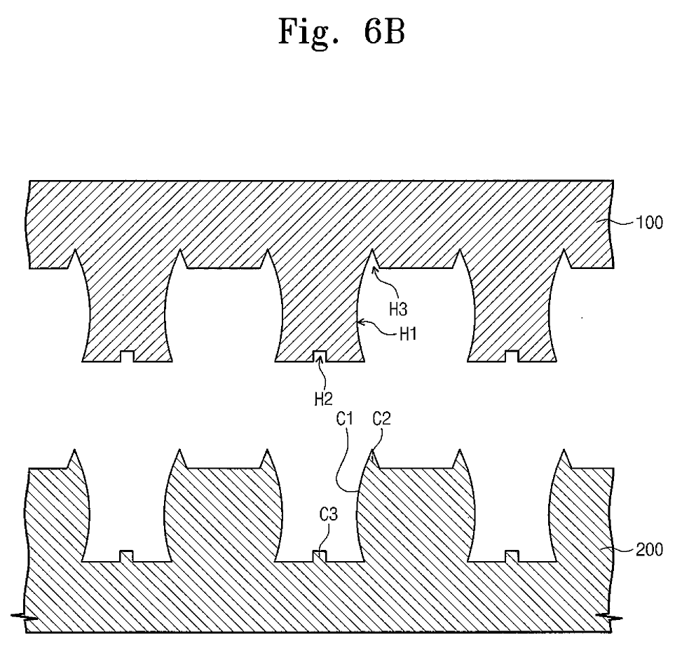

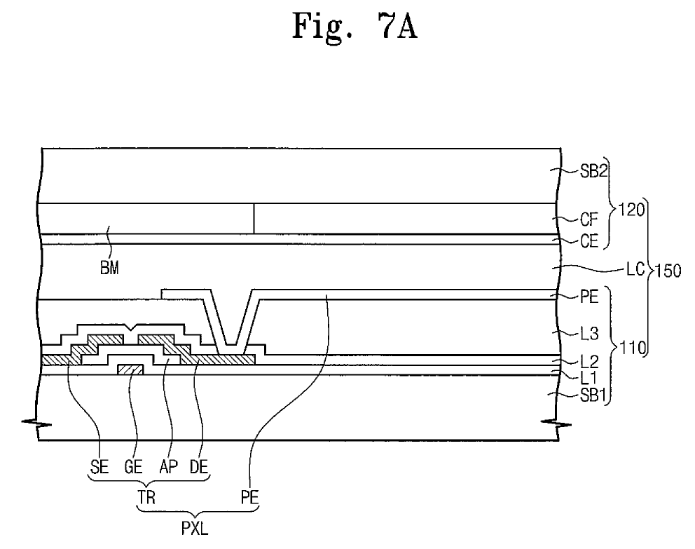

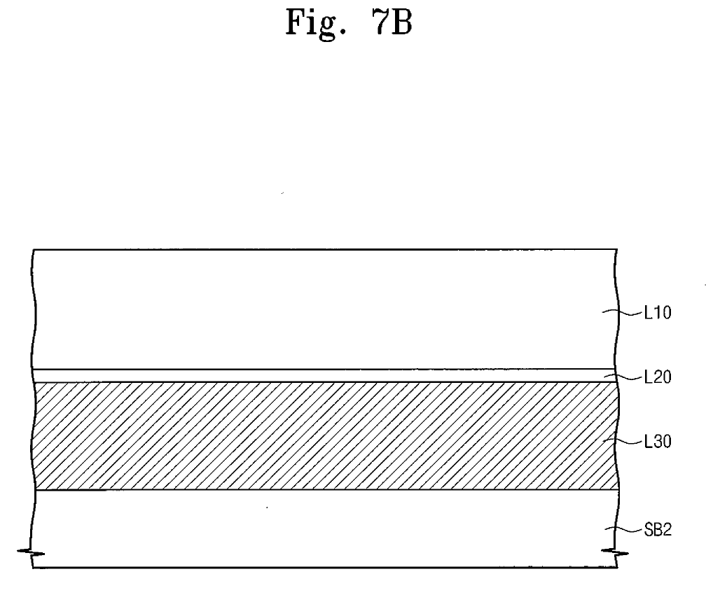

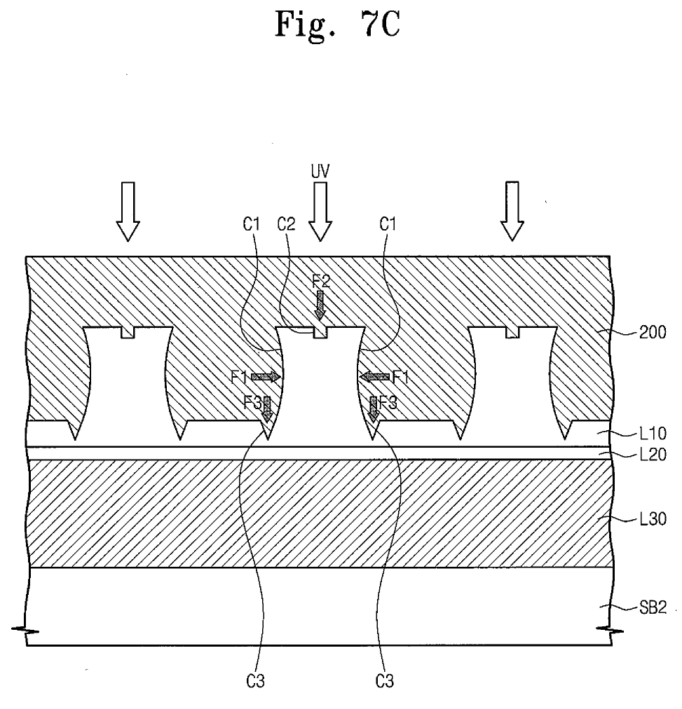

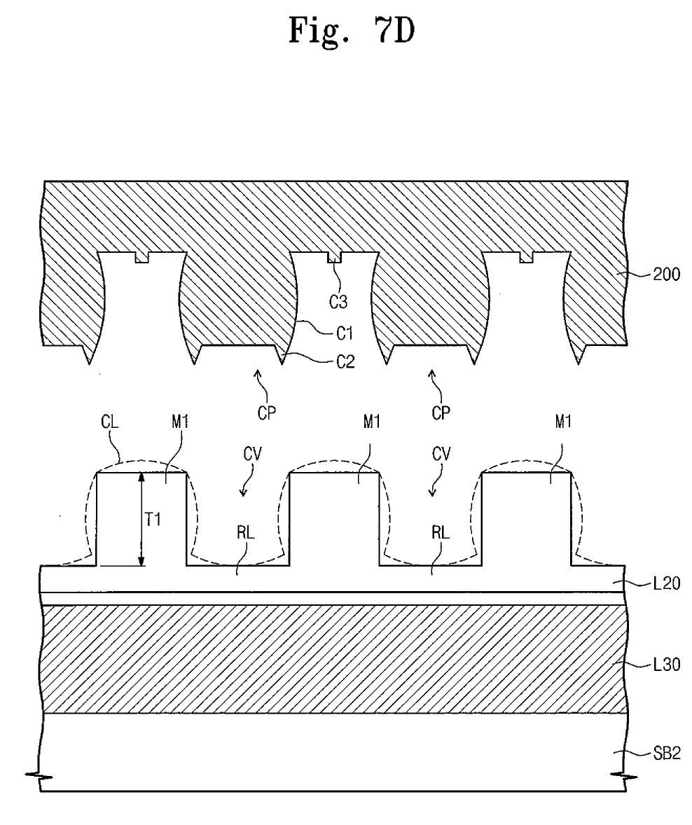

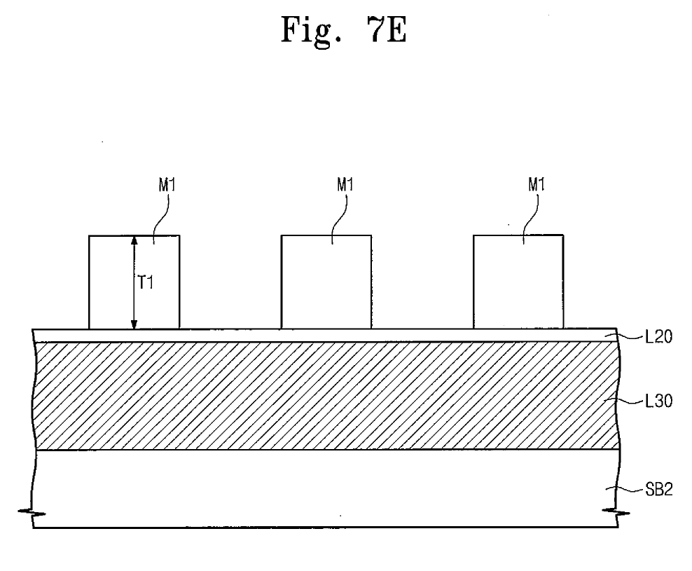

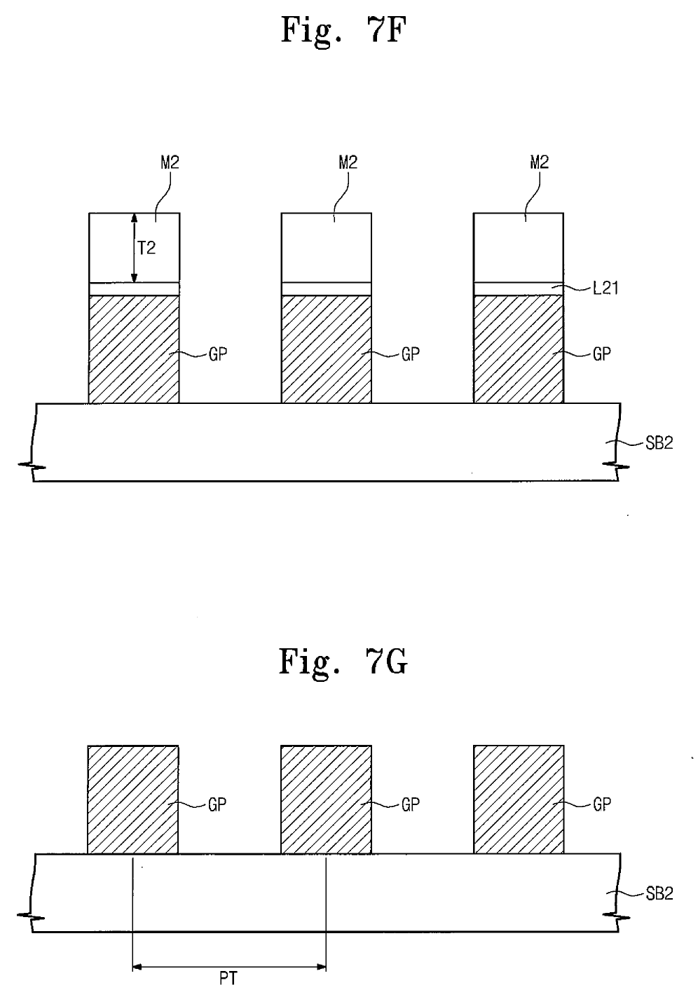

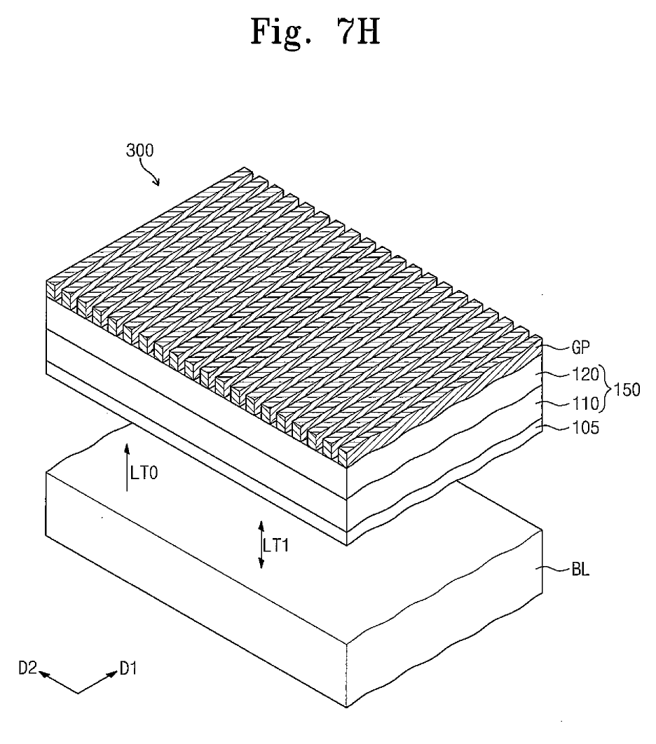

Referring to the embodiments shown in FIGS. 5A and 5B, the imprint mold 200 is used (utilized) to manufacture grid polarization layers GP (as shown in FIG. 7H) of a display device 300 (as shown in FIG. 7H) using (utilizing) an imprint method. In addition, the imprint mold 200 may be manufactured by an imprint method using (utilizing) a master mold 100 (as shown in FIGS. 6A and 6B) such that a pattern may be formed on a base part BP′ of the imprint mold 200 by transferring the pattern formed on the base part BP (as shown in FIG. 1B and previously described) of the master mold 100.

The imprint mold 200, in an embodiment, includes an organic material, e.g., a silicon resin, an epoxy resin, etc. The imprint mold 200, in an embodiment, includes the base part BP′ and a plurality of protrusions CP′. In an embodiment, the base part BP′ has a plate shape and the protrusions CP′ extend from the base part BP′.

In an embodiment, the protrusions CP′ are on the base part BP′ and extend along a first direction D1. The protrusions CP′, in an embodiment, are also arranged along a second direction D2 crossing the first direction D1 at regular intervals. In an embodiment, the first direction D1 may be substantially perpendicular to the second direction D2. Hereinafter, one protrusion CP′ of the plurality of protrusions CP′ will be described in further detail as a representative example.

The protrusion CP′, in an embodiment, includes side portions P1′ with adjacent side portions P1′ facing each other, and a first convex portion C1 protruding from each of the side portions P1′. The first convex portion C1 may be defined by a surface extending along the first direction D1 and having a rounded convex contour or cross-sectional shape. More specifically, the first convex portion C1, in an embodiment, is defined by a protrusion outward at the center of each of the side portions P1′, as shown in FIGS. 5A and 5B. Accordingly, if a third imaginary line LN3 were defined along the first direction D1 to halve each of the side portions P1′, as shown in FIG. 5A, the first convex portion C1 would have its greatest thickness WT on the third imaginary line LN3 halving each side portion P1′.

According to another embodiment, although the thickness WT of the first convex portion C1 is greatest on the third imaginary line LN3 as described above, surfaces defining the first convex portion C1 may have a flat cross-sectional shape.

The protrusion CP′, according to an embodiment, includes an upper portion P2′ having second convex portions C2 formed on the upper portion P2′. The second convex portions C2, in this embodiment, are at two edges of the upper portion P2′ which face each other, and each of the second convex portions C2 has a polygonal contour or cross-sectional shape. According to another embodiment, each of the second convex portions C2 may have a semi-circular contour or cross-sectional shape.

In this embodiment, the imprint mold 200 further includes third convex portions C3 extending from the base part BP′ along the first direction Dl. The protrusion CP′, in this embodiment, is between two adjacent third convex portions C3, and each of the third convex portions C3 has a first height HT1 less than a height HT2 of the protrusion CP′ (measured to the upper portion P2′). Each of the third convex portions C3, in this embodiment, has a polygonal contour or cross-sectional shape, but is not limited thereto or thereby. For example, according to another embodiment, each of the third convex portions C3 has a semi-circular contour or cross-sectional shape.

FIGS. 6A and 6B are cross-sectional views illustrating a method of manufacturing the imprint mold 200 shown in FIG. 5B using (utilizing) the master mold 100 shown in FIG. 1A. In FIGS. 6A and 6B, the same reference numerals denote the same elements in FIGS. 1A, 5A, and 5B, and, thus, detailed descriptions of the same elements will be omitted.

Referring to the embodiments illustrated in FIGS. 6A and 6B, a resin layer 200-1 is imprinted on the master mold 100 and an ultraviolet ray UV is irradiated onto the resin layer 200-1 imprinted on the master mold 100, thereby curing the resin layer 200-1. In this embodiment, the resin layer 200-1 includes a polymer resin, such as an epoxy resin, and a photo-initiator, allowing for it to be cured by the ultraviolet ray UV.

In this embodiment, after the resin layer 200-1 imprinted on the master mold 100 is cured by the ultraviolet ray UV, the master mold 100 is separated from the resin layer 200-1. As a result, the pattern of the master mold 100 is transferred to the resin layer 200-1, creating the imprint mold 200. Since the imprint mold 200 is manufactured by imprinting the master mold 100, in this embodiment, the first convex portions C1 are formed on the imprint mold 200 corresponding to and/or complementary with the first recesses H1 of the master mold 100 in a one-to-one relationship. In this embodiment, the third convex portions C3 are formed on the imprint mold 200 corresponding to and/or complementary with the second recesses H2 of the master mold 100 in a one-to-one relationship, and the second convex portions C2 are formed on the imprint mold 200 corresponding to and/or complementary with the third recesses H3 in a one-to-one relationship.

FIGS. 7A to 7H are cross-sectional and perspective views illustrating a method of manufacturing a display device using (utilizing) the imprint mold 200 shown in FIGS. 5A and 5B. More specifically, FIGS. 7A to 7H are views illustrating a method of manufacturing grid polarization layers of the display device using (utilizing) the imprint mold 200. In FIGS. 7A to 7H, the same reference numerals denote the same elements in FIGS. 5A and 5B, and, thus, detailed descriptions of the same elements will be omitted.

Referring to the embodiment illustrated in FIG. 7A, a pixel part PXL is formed on a first substrate SB1. The pixel part PXL, in this embodiment, includes a thin film transistor TR and a pixel electrode PE electrically connected or coupled to the thin film transistor TR.

The thin film transistor TR, in an embodiment, is formed by forming a gate electrode GE on the first substrate SB1, forming an active pattern AP on the gate electrode GE with a first insulating layer L1 between the gate electrode GE and the active pattern AP, and forming a source electrode SE and a drain electrode DE on the active pattern AP and on the first insulating layer L1, the source electrode SE and the drain electrode DE being spaced apart from each other and overlapping the active pattern AP.

In an embodiment, after forming the thin film transistor TR, a second insulating layer L2 that covers the thin film transistor TR and a third insulating layer L3 are sequentially formed and a contact hole is formed through the third insulating layer L3. The pixel electrode PE, in this embodiment, is formed on the third insulating layer L3 and connected or coupled to the drain electrode DE through the contact hole in the third insulating layer L3. As a result, a display substrate 110 including the pixel part PXL is manufactured, according to the embodiment described above.

In an embodiment, to manufacture an opposite substrate 120 coupled to the display substrate 110, a color filter CF and a light blocking layer BM are formed on a second substrate SB2. The color filter CF, in this embodiment, is formed at a position corresponding to that of the pixel electrode PE, and the light blocking layer BM is formed at a position corresponding to that of the thin film transistor TR. According to this embodiment, a common electrode CE is formed to cover the light blocking layer BM and the color filter CF, thus, completing the manufacturing process of the opposite substrate 120, according to an embodiment.

The manufacturing method of the display substrate 110 and the opposite substrate 120 is not limited to the above-mentioned method. For example, the color filter CF may be formed on the first substrate SB1 instead of the third insulating layer L3 of the display substrate 110.

In an embodiment, after the display substrate 110 and the opposite substrate 120 have been manufactured, a liquid crystal layer LC is formed between the display substrate 110 and the opposite substrate 120, with the display substrate 110 and the opposite substrate 120 being coupled to each other to complete the manufacture of the display panel 150.

Referring to the embodiment illustrated in FIG. 7B, a preliminary grid polarization layer L30 is formed on the second substrate SB2. The preliminary grid polarization layer L30 is used (utilized) to form the grid polarization layers GP (as shown in FIG. 7G) and is formed of an aluminum material.

In an embodiment, after the preliminary grid polarization layer L30 is formed, an auxiliary layer L20 is formed on the preliminary grid polarization layer L30 extending over the preliminary grid polarization layer L30. In an embodiment where the preliminary grid polarization layer L30 is formed of aluminum, the auxiliary layer L20 may be formed of titanium, thus preventing or reducing the occurrence of a hillock phenomenon due to protuberances formed on the surface of the preliminary grid polarization layer L30 while aluminum included in the preliminary grid polarization layer L30 expands at a high temperature.

In an embodiment, a resin layer L10 is formed on the auxiliary layer L20. In this embodiment, the resin layer L10 may include a polymer resin, e.g., an epoxy resin, and a photo-initiator.

Referring to the embodiments illustrated in FIGS. 7C and 7D, the resin layer L10 is imprinted using (utilizing) the imprint mold 200 with the ultraviolet ray UV irradiated onto the resin layer L10 imprinted by the imprint mold 200, thereby curing the resin layer L10. In this embodiment, after the resin layer L10 is cured, the imprint mold 200 is separated from the cured resin layer L10. As a result, first mask layers M1 including the cured resin layer L10 formed on the auxiliary layer L20 are formed, and a residual layer RL is formed at a lower portion of the first mask layers M1. In addition, concave portions CV are formed between adjacent first mask layers M1.

In an embodiment, when the resin layer L10 is pressed by the imprint mold 200, the resin of the resin layer L10, which is pressed by the protrusions CP of the imprint mold 200, reflows to form the residual layer RL, and substantially simultaneously, the concave portion CV is formed at a position corresponding and/or complementary to the protrusion CP. In addition, the first mask layers M1 are formed to correspond to the concave portions C1, C2, and C3 of the imprint mold 200 while the resin layer L10 is pressed by the imprint mold 200.

In an embodiment, the imprint mold 200 includes polymer resin, thus the imprint mold 200 has soft material properties. In this embodiment, the first mask layers M1 have a pitch that is tens of nanometers shorter than that of visible light. In an embodiment, the resin layer L10 includes a polymer resin having viscosity such that when the resin layer L10 is pressed by the imprint mold 200, a width in the concave portions of the imprint mold 200 becomes wider due to a low dispersion property of the polymer resin or attractive force occurring between molecules of the polymer resin.

In other examples, when the imprint mold 200 excludes the first, second, and third protrusions C1, C2, and C3, and each of the protrusions CP has a tetrahedral shape, the shape of the protrusions CP may not be maintained by the resin layer L10 while the resin layer L10 is pressed by the imprint mold 200. Accordingly, the profile associated with the first mask layers M1 may have a round shape along an imaginary line CL.

However, according to an embodiment, when the resin layer L10 is pressed by the imprint mold 200, a first force F1 is applied to the resin layer L10 by the first convex portions C1 such that the profile of side portions of the first mask layers M1 becomes flat near the straight line. In this embodiment, a second force F2 is applied to the resin layer L10 by the second convex portions C2 such that the profile of the upper portions of the first mask layers M1 becomes flat near the straight line. Further, in this embodiment, a third force F3 is applied to the resin layer L10 by the third convex portions C3 such that the profile of the residual layer RL becomes flat near the straight line.

Referring to the embodiments illustrated in FIGS. 7E and 7F, the residual layer RL is removed through an etching process. After removal of the residual layer RL, the auxiliary layer L20 and the preliminary grid polarization layer L30 are etched using (utilizing) the first mask layers M1 as a mask. As a result, grid polarization layers GP and auxiliary patterns L21 are formed on the second substrate SB2, according to an embodiment.

In an embodiment, the first mask layers M1 are partially etched to form second mask layers M2 when the residual layer RL, the auxiliary layer L20, and the preliminary grid polarization layer L30 are etched. Therefore, in this embodiment, each of the first mask layers M1 has a first thickness T1 and each of the second mask layers M2 has a second thickness T2 less than the first thickness T1.

Referring to the embodiment illustrated in FIG. 7G, the second mask layers M2 (as shown in FIG. 7F) are removed, and the grid polarization layers GP remain on the second substrate SB2, which are spaced apart from each other. In this embodiment, the grid polarization layers GP are formed to have a pitch PT that is tens of nanometers shorter than a wavelength of visible light.

In other examples, when the cross-sectional profile of the first mask layers and the residual layer has a rounded shape along the imaginary line CL (as shown in FIG. 7D), the etch processes are performed using (utilizing) the first mask layers M1 (as shown in FIG. 7D) and the second mask layers M2 (as shown in FIG. 7F) described with reference to FIGS. 7E and 7F, the profile of the second mask layers is formed by etching the first mask layers M1 and the grid polarization layers GP patterned using (utilizing) the second mask layers because it may be difficult for the mask to have a tetrahedral shape. However, according to an embodiment of the present invention, because the profile of the first mask layers M1 and the residual layer RL becomes flat near the straight line by the first, second, and third convex portions C1, C2, and C3 (as shown in FIG. 7C) of the imprint mold 200, the grid polarization layers GP have a flat profile.

Referring to the embodiments illustrated in FIGS. 7A and 7H, a polarization plate 105 is positioned under the display substrate 110, and a backlight unit BL is positioned under the display panel 150 after the grid polarization layers GP are formed on the second substrate SB2 of the opposite substrate 110, thus completing manufacturing of the display device 300.

In an embodiment, the grid polarization layers GP extend along the first direction D1 and are arranged along the second direction D2 at the pitch PT (as shown in FIG. 7G). In embodiments of the grid polarization layers GP having the above-mentioned structure, when the pitch PT is less than a wavelength of an emitted light LT0 emitted from the backlight unit BL and incident to the grid polarization layers GP, the grid polarization layers GP may serve as a wire-grid polarizer polarizing or reflecting the emitted light LT0 in accordance with a direction in which the emitted light LT0 vibrates. For example, a light component that vibrates in a direction substantially perpendicular to the first direction D1 may be referred to as a P-polarized light component and a light component that vibrates in a direction substantially in parallel to the first direction D1 may be referred to as an S-polarized light component, and the P-polarized light component transmits through the grid polarization layers GP while the S-polarized light component is reflected by the grid polarization layers GP.

In an embodiment, the S-polarized light component reflected by the grid polarization layers GP is re-reflected by a reflection member included in the backlight unit BL and converted to a reflection light LT1 having another P-polarized light component and another S-polarized light component. The P-polarized light component of the reflection light LT1, in this embodiment, transmits through the grid polarization layers GP, and the S-polarized light component of the reflection light LT1 is re-reflected by the grid polarization layers GP. According to the above-mentioned function of the grid polarization layers GP, an efficiency of the emitted light LT0 used (utilized) to display an image on the display panel 150 may be improved as a result of the grid polarization layers GP.

Although embodiments of the present invention have been described above, it is understood that the present invention should not be limited to these exemplary embodiments, but various changes and modifications can be made by one ordinary skilled in the art within the spirit and scope of the present invention and as hereinafter claimed and equivalents thereof.

What is claimed is:

1. A master mold for manufacturing an imprint mold, comprising:
a base part; and
a plurality of protrusions extending from the base part, wherein at least one first recess is defined in a side portion of each of the protrusions.

2. The master mold of claim 1, wherein each of the protrusions extends along a first direction, and the protrusions are arranged on the base part along a second direction crossing the first direction to be spaced apart from each other.

3. The master mold of claim 2, wherein the first recess extends along the first direction, having its greatest depth at a centerline extending along the first direction at the side portion.

4. The master mold of claim 3, wherein the first recess is defined by a surface comprising a rounded shape.

5. The master mold of claim 2, wherein at least one second recess is defined in an upper portion of each of the protrusions.

6. The master mold of claim 5, wherein, the at least one second recess extends along a centerline of the upper portion of each of the protrusions along the first direction.

7. The master mold of claim 2, wherein each of the protrusions comprises auxiliary protrusions at two edges of an upper portion of each of the protrusions such that a corresponding one of the auxiliary protrusions is on each of the two edges.

8. The master mold of claim 7, wherein each of the auxiliary protrusions comprises a polygonal cross-sectional shape.

9. The master mold of claim 2, wherein at least one third recess is defined on the base part, the third recess extending along the first direction.

10. The master mold of claim 9, wherein the first recess is coupled to the third recess.

11. An imprint mold for manufacturing a display device, comprising:
a base part; and
a plurality of protrusions extending from the base part, wherein each of the protrusions comprises at least one first convex portion protruding from a side portion of each of the protrusions.

12. The imprint mold of claim 11, wherein each of the protrusions extends along a first direction, and the protrusions are arranged on the base part in a second direction crossing the first direction to be spaced apart from each other.

13. The imprint mold of claim 12, wherein the first convex portion extends in the first direction having a greatest thickness at a centerline extending along the first direction at the side portion.

14. The imprint mold of claim 12, wherein each of the protrusions further comprises second convex portions at two upper edges facing each other such that a corresponding one of the second convex portions is on each of the two upper edges.

15. The imprint mold of claim 14, wherein each of the second convex portions comprises a polygonal cross-sectional shape.

16. The imprint mold of claim 12, further comprising a third convex portion protruding from the base part and extending along the first direction between two adjacent protrusions of the plurality of protrusions, wherein the third convex portion has a height less than that of each of the protrusions.

17. A method of manufacturing a display device utilizing an imprint mold, comprising:
forming a pixel part on a first substrate;
forming a preliminary grid polarization layer on at least one of the first substrate and a second substrate facing the first substrate;
forming a resin layer on the preliminary grid polarization layer;
imprinting the resin layer utilizing the imprint mold comprising a base part and a plurality of protrusions extending from the base part to form an imprinted resin layer;
curing the imprinted resin layer to form mask layers; and
patterning the preliminary grid polarization layer utilizing the mask layers as a mask to form grid polarization layers, wherein a profile of a side portion of each of the mask layers is flattened utilizing a first convex portion on a side portion of each of the protrusions during imprinting of the resin layer.

18. The method of claim 17, wherein, during the imprinting of the resin layer by the imprint mold, a profile of a residual layer under the mask layers is flattened utilizing a second convex portion on an upper portion of each of the protrusions.

19. The method of claim 17, wherein, during the imprinting of the resin layer by the imprint mold, a profile of an upper portion of each of the mask layers is flattened utilizing a third convex portion on the base part.

20. The method of claim 17, wherein the grid polarization layers have a pitch shorter than a wavelength of a visible light, and the visible light is polarized or reflected by the grid polarization layers.
